(19) United States
(12) Patent Application Publication
(10) Pub. No.: US 2019/0217601 A1
(43) Pub. Date: Jul. 18, 2019

(54) Method for Producing an Edge Profile and Furniture Component

(71) Applicant: Fritz EGGER GmbH & Co. OG, St. Johann in Tirol (AT)

(72) Inventor: Thomas Streichardt, Warendorf (DE)

(21) Appl. No.: 16/302,802

(22) PCT Filed: May 11, 2017
(86) PCT No.: PCT/EP2017/061367

§ 371 Date: Nov. 19, 2018

(30) Foreign Application Priority Data
May 20, 2016 (DE) 10 2016 109 361.0

(51) Int. Cl. B41F 19/06; B41F 19/04; B41F 19/00; B29C 59/02; B29C 59/04; B44C 1/24; B44C 5/04

(52) U.S. Cl. CPC B41F 19/062; B41F 19/04; B41F 19/007; B29C 59/022; B29L 2031/722; B44C 1/24; B44C 5/04; B41P 2219/43; B29C 59/046

(57) ABSTRACT

The invention relates to a method for producing an edge profile for a narrow surface of a plate-shaped material, wherein an edge band extending in a longitudinal direction has a decoration, and wherein the edge band has a three-dimensional structure. In order to further improve a furniture part with regard to optical and haptic properties, the decoration and the structure according to the invention are arranged in such a way that the structure is at least substantially congruent with the decoration. The invention further relates to a corresponding furniture part having a plate-shaped material, which has at least one narrow surface, an upper part, and a lower part, and at least one edge profile.

The present invention relates to a method for producing an edge profile for a narrow face of a plate-like material, wherein an edge strip which extends in a longitudinal direction is provided with a decoration and wherein the edge strip is provided with a three-dimensional structure.

The invention further relates to a furniture component having a plate-like material which has at least one narrow face and an upper side and a lower side, and having at least one edge profile.

There are known from the prior art furniture panels which are provided with a wood decoration and which have a three-dimensional structure which is adapted to the wood decoration. In other words, the structure extends congruently with the decoration, that is to say, a portion of the structure, in particular recesses or projections, extend each congruently with a decoration element. A structure which is adapted to a decoration, for example, a wood decoration, is also referred to as a synchronous structure or “Synchronpore” or is called “embossed-in-register”. In this case, the decoration and structure are part of a coating which has been applied to a plate-like material, in particular a wood material panel.

In order to produce such decoratively coated furniture panels, different methods are known. Thus, EP2700511 A1 describes a method for producing a plate-like furniture component, wherein papers which are printed with a wood decoration and which are impregnated with synthetic resin are compressed with the upper side and the lower side of a wood material panel. For compression, structured pressing plates are orientated relative to the decoration and thus a structure with synchronous decoration is embossed into the two plate surfaces.

EP1645339 A1 describes another method. In this instance, the three-dimensional structure is not embossed, but instead applied to the decoration. Thus, a directly printed carrier plate is provided with a transparent seal, on which a structure is printed by means of a matt or coloured lacquer. Such a structure is also referred to as a lacquer pore. In this method, according to an embodiment, the structure can also be constructed as a synchronous structure, that is to say, as a structure with a synchronous decoration, in this method.

It is also known to adhesively bond an edge profile, also referred to as an edge strip, to the narrow faces of a plate-like material, for example, a furniture panel. This edge profile is used, on the one hand, as a visually attractive closure of the furniture panels at the narrow faces thereof and, on the other hand, the wood material is thereby protected from moisture and impacts. Different types of edge profiles or edge strips are known.

Firstly, there are known paper-based edge profiles which comprise a layer structure comprising one or more papers which are impregnated with resin. The resin is, for example, melamine resin or another thermosetting resin. At least one decoration paper which is printed with a decoration and, where applicable, one or more core papers is/are used as papers. Edge profiles of this type are used, for example, for edging narrow faces of coated wood materials, such as chipboard, MDF, HDF, plywood and veneer panels. The finished furniture panels can again be used as carcass components, fronts, work panels, etc.

In the paper-based edge profiles, the decoration can be printed before or after the impregnation of the respective paper. The layer structure provided with the decoration can then be polymerised by compression or simple drying. It is also known to impress a three-dimensional structure, for example, by embossing a layer before compression or by embossing the entire layer structure during compression.

The edge strips which are produced in this manner can in principle also be produced with a greater width than the definitive width, for example, with widths of from 50 to 150 cm. In this case, the edge strips are then cut into strips in accordance with the length, wherein the narrower edge strips which are produced in this manner then form the respective edge profile.

In addition to the above-described paper-based or thermosetting edge profiles, there are also known thermoplastic edge profiles, also referred to as extrusion profiles, which are also used for decorative narrow face coating of wood materials, such as chipboard, MDF, HDF and lightweight construction panels and which take on both a protective function and a design function. The edge profiles are produced by extrusion of a thermoplastic plastics material, for example, ABS (acrylonitrile butadiene styrene) and are usually dyed over the entire surface. These edge profiles can be used in the production of furniture items for kitchens, bathrooms, offices, etc. As a result of the great robustness, they can also be used in the construction of exhibitions and shop fitting.

The extrusion of an edge strip which subsequently forms a thermoplastic edge can be carried out in different manners. Thus, a distinction is made between single-strand extrusion, on the one hand, and the calender method, on the other hand.

In the case of single-strand extrusion, there is used an extrusion tool which substantially has the profile of the finished edge, that is to say, the definitive edge profile. In the case of the calender method, however, the extrudate is supplied, for example, by means of a wide-slot nozzle, to a calender, between the rollers of which there is formed a relatively wide edge strip which where applicable is subsequently again cut into strips in accordance with the desired edge width.

Edge strips produced by extrusion can also be provided with a three-dimensional structure, wherein a separate embossing roller generally embosses the structure in the still-soft, pasty state. However, it is also known to allow the edge strip to cool first and subsequently to heat it so powerfully by means of energy-rich radiation, for example, infrared radiation, at the surface that an embossing roller can subsequently emboss the structure. During the calender method, a three-dimensional structure can also be embossed by one of the calender rollers being structured. In both cases, that is to say, both in the case of single-strand extrusion and in the case of the calender method, a decoration can also be applied to the edge strip, which can be carried out before or after the embossing of the edge strip.

The decoration printing is carried out in the above-described edge profiles, for example, by means of a digital printing method, wherein a printing head of a laser printer or ink jet printer prints the decoration onto the surface which is intended to be printed. Such a method for printing an edge profile is described, for example, in DE 198 23 195 C2.

Paper-based and thermoplastic edge profiles can be provided in principle with a wood or stone decoration. For furniture components which are intended to imitate a component comprising solid wood or stone particularly well, it is preferable to select a paper-based or thermoplastic edge with a decoration which corresponds to the upper side of the furniture component.

An object of the present invention is to provide a furniture component which is further improved in terms of visual and haptic properties.

The object derived and set out above is achieved according to a first aspect of teaching of the present invention in a method for producing an edge profile for a narrow face of a plate-like material, for example, a wood material plate or a lightweight construction panel,
wherein an edge strip, in particular a continuous strip, which extends in a longitudinal direction is provided with a decoration which has in particular at least one decoration element and
wherein the edge strip is provided with a three-dimensional structure which has in particular at least one recess or projection,
   in that the decoration and the structure are arranged in such a manner that the structure is at least substantially congruent with the decoration.

Therefore, at least a portion of the structure, in particular one or more recess(es) or projection(s), extends according to the invention congruently with a decoration element of the decoration. It has been recognised that particularly in furniture components which are provided with a synchronous structure at both sides, that is to say, both at the upper side and at the lower side thereof, the use of such an edge profile which also has a synchronous structure, brings a further improved similarity to a material which is intended to be imitated, for example, wood. Particularly in the case of great narrow faces, as provided, for example, in kitchen work panels, the impression of a panel of solid wood is achieved, especially if the decoration and structure of the coating at the upper side and/or lower side correspond to the coating at the narrow face. Preferably, it is even conceivable, in a plate-like material which is provided, for example, with a coating of a wood decoration, to provide two mutually parallel narrow faces with a decoration and a synchronous structure which is identical to the decoration and structure of the upper side or lower side of the plate and to provide the other two mutually parallel narrow faces with a decoration which is different therefrom and a synchronous structure which is different therefrom, which conveys, for example, the impression of timber cut in the cross-grain direction. The upper side or lower side and the first two parallel narrow sides would then convey the impression of timber cut longitudinally so that overall differences from real solid wood can scarcely still be identified.

Different embodiments of the method according to the invention for producing an edge profile are now described below and are also the subject-matter of the dependent claims.

According to a first embodiment of the method according to the invention, there is provision for the edge strip to be produced by extruding a thermoplastic plastics material and where applicable by subsequently cutting it in the longitudinal direction of the edge strip. Therefore, on the one hand, an edge strip is intended to be understood to be an extruded strip which is not subsequently cut but, on the other hand, also a strip which is produced by cutting the extrudate. Both variants of an edge strip can form an edge profile in accordance with the invention if they are provided with a decoration and a structure which has synchronous decoration. Alternatively, the edge strip may also be produced by compressing or drying, and thereby hardening, a paper-based layer structure which has one or more layers, wherein the paper(s) is/are impregnated with a thermosetting resin.

According to another embodiment of the method according to the invention, there is provision for the edge strip to be provided with the structure within a time period after the production of said edge strip, in particular extrusion, in which the plastics material of the edge strip does not yet have the definitive form stability. According to this embodiment, therefore, the structure is embossed in the extrudate in the still-soft or pasty state.

According to another embodiment of the method according to the invention, there is provision for the edge strip to be provided with the structure within a time period after the production of said edge strip, in particular extrusion, in which the plastics material of the edge strip already has the definitive form stability. Therefore, it is also conceivable initially to allow the extrudate to harden completely, where applicable to store it temporarily, in particular as rolled goods, and subsequently to heat it at least superficially and thereby to soften it in the region in which the embossing is intended to be carried out. The heating is carried out in particular by means of energy-rich radiation, for example, infrared radiation.

According to another embodiment of the method according to the invention, there is provision for the edge strip to be provided first with the decoration and subsequently with the structure. This is intended to be understood to mean that the decoration is provided at a predetermined location of the edge strip in a first step, in particular by printing the upper side, that is to say, the side which is visible later, for example, by means of a digital printing or intaglio printing method, wherein in a subsequent second step the structure is embossed at this location (provided with the decoration beforehand).

According to an alternative embodiment of the method according to the invention, there is provision for the edge strip to be provided first with the structure and subsequently with the decoration. Therefore, it is also conceivable to have the case that in a first step first the structure is embossed at a predetermined location of the edge strip and subsequently in a separate second step the decoration is applied, wherein the application (impression) is carried out in particular or only in the recessed portions and not in the protruding portions of the embossing. Finally, it is also conceivable to provide another application in the protruding portions, for example, in a different colour from that in the recessed portions of the embossing. It is thereby possible to produce a structure with a synchronous decoration in a particularly simple manner.

According to another embodiment of the method according to the invention, there is provision for the decoration to be applied to the edge strip by means of intaglio printing, in particular indirect intaglio printing, using one or more impression cylinder(s). The term intaglio printing method is intended to be understood to be a printing technique in which an impression cylinder has projecting portions and recessed portions, this impression cylinder is provided with dye by being immersed, for example, in a dye bath so that both the projecting and the recessed portions come into contact with the dye, subsequently the dye is scraped off the projecting portions with a doctor blade or a wiper so that dye is still located only in the recessed portions and finally the impression cylinder and the surface of the edge strip which is intended to be printed are pressed together, whereby the dye is transmitted from the recessed portions to the surface of the edge strip. A corresponding decoration is repeated in accordance with the circumference of the respective impression cylinder. In principle, this operation can also be repeated using a plurality of such impression cylinders, in particular with different dyes and/or different shapes of the recessed or projecting portions and/or different circumferences.

According to another embodiment of the method according to the invention, there is provision for the structure to be impressed into the edge strip by means of one or more embossing roller(s). The embossing roller(s) has/have recessed and projecting portions, similarly to the above-described impression cylinders, wherein the projecting portions are introduced into the edge strip and thereby produce the embossing. In this instance, a plurality of embossing rollers one after the other can also provide for an embossing, wherein in this case the shape of the projecting or recessed portions and/or the circumference of the embossing rollers may also differ from each other. In principle, a roller without an individual embossing structure may also be provided, wherein a structuring film or the like (structuring paper) is then guided along between the roller and the extruded edge strip.

According to another embodiment of the method according to the invention, there is provision for the at least one embossing roller to be a calender roller of a calender. A calender comprises a plurality of calender rollers which are arranged under and/or beside each other and which are spaced apart by a predetermined gap relative to the adjacent calender roller(s). The extrudate is guided through between a plurality of pairs of adjacent calender rollers and thereby formed. If one of the calender rollers is an embossing roller, an impression is automatically provided in the surface of the edge strip or extrudate. Preferably, the embossing roller is a calender roller of the last pair of calender rollers, through which the extrudate is guided.

According to another embodiment of the method according to the invention, there is provision for the circumference of the impression cylinder(s) and the embossing roller(s) to be selected in such a manner that, if the edge strip comes into contact with impression cylinder(s) and embossing roller(s), the decoration and structure are moved so as to at least substantially overlap with each other. Should there nevertheless be produced, as a result of tolerances, a possible slight offset between the decoration and the structure in a longitudinal direction, the size of the offset in a longitudinal direction does not change (without counter-measures) because the impression cylinder(s) and embossing roller(s) always run synchronously with each other as a result of the circumferences which are adapted to each other.

In order to achieve such synchronicity, there is particularly provision for the circumference of the embossing roller(s) to correspond to the circumference of the impression cylinder(s) or an integral multiple of the circumference of the impression cylinder(s).

Additionally or alternatively, there may also be provision for the circumference of the impression cylinder(s) to correspond to an integral multiple of the circumference of the embossing roller(s).

In the event of an offset, it is also conceivable for there to be provided an automated control device which identifies the offset in the longitudinal direction between the decoration and structure (in good time) and which re-adjusts the advance speed of the edge strip and/or the rotation speed of one or more impression cylinder(s) and/or one or more embossing roller(s).

According to another embodiment of the method according to the invention, there is provision for the decoration to be applied to the edge strip by means of digital printing (using a device for digital printing, in particular using a printing head, in particular an ink jet printing head or laser printing head). If the edge strip is a paper-based edge strip, it is also conceivable to print the decoration initially on a decoration paper of the subsequent layer structure, wherein the application can be carried out before or after the impregnation of the decoration paper with the thermosetting resin. Subsequently, the decoration paper which is printed in this manner is compressed or dried in the layer structure.

According to yet another embodiment of the method according to the invention, there is provision for a printing device for digital printing or the impression cylinder or one of the impression cylinders or the embossing roller or one of the embossing rollers or a separate marking device to provide for a marking on the edge strip several times, in particular at regular intervals. A marking may be understood to refer to a graphic (for example, printed) marking or a three-dimensional (for example, embossed) marking. As a result of such markings, an adjustment of the following impression cylinders and/or the embossing rollers can be carried out in a particularly simple manner so that the impression of the respective following impression cylinder or the impression of the following embossing roller always has the same spacing from the next marking.

According to another embodiment of the method according to the invention, there is provision for the respective marking to be provided as a separate marking on the edge of the edge strip or on the rear side (the side which cannot be seen in the subsequent mounted state) of the edge strip or to be integrated in the decoration and/or the structure. The term “separate marking” is intended to be understood to mean that the marking is applied in a separate step independently of the decoration and/or the structure. In principle, however, a specific defined location of the repeating decoration or the repeating structure may also form a marking.

A marking may be provided preferably at the edge of the edge strip particularly when the edge strip during subsequent production thereof is further divided in accordance with the length, wherein preferably such a wide peripheral strip of the edge strip is separated that no further marking can be identified on the remaining edge strip. Should the edge strip no longer be intended to be laterally cut subsequently, however, it may be preferable to provide the marking on the rear side thereof so that the marking is subsequently covered in the assembled state of the edge profile. In principle, however, the marking may, as set out, also be integrated in the decoration and/or the structure, in particular as a portion of the decoration and/or the structure, so that the marking cannot be identified per se by an observer (so-called “concealed register marking”).

According to another embodiment of the method according to the invention, there is provision for the respective marking to be detected, in particular with a scanning device, for example, an optical scanning device, and to be used by a control device to control the advance speed of the edge strip and/or the printing speed of a device for digital printing and/or the rotation speed of the impression cylinder(s) and/or the embossing roller(s) and/or to adapt the digital decoration which is intended to be printed (decoration data on a computer). The control is carried out in particular automatically, wherein the scanning device preferably identifies any marking and transmits a corresponding signal to the control device.

It is particularly conceivable for the control device to compare the position of the respective marking with the angular position (relative to the strip surface) of the impression cylinder(s) and/or the embossing roller(s) and to carry out a control operation on the basis of the comparison result. To this end, a marking may also be provided on the respective impression cylinder and/or the respective embossing roller, in particular on the cylinder base face of the respective impression cylinder or the respective embossing roller, wherein this marking can also be detected by a scanning device, for example, an optical scanning device, and a corresponding signal can be transmitted to the control device.

According to an alternative embodiment of the method according to the invention, there is provision for the control device to compare the position of the respective marking provided on the edge strip with the position of the device for digital printing, in particular the printing head (relative to the strip surface), and to carry out a control operation on the basis of the comparison result.

The above-described control operation and the associated adaptation can further also include a displacement of the respective impression cylinder or the respective embossing roller or the edge strip which is intended to be printed or embossed in a transverse direction (direction orthogonal to the longitudinal direction), whereby an offset between the decoration and the structure in a transverse direction can also be compensated for or prevented.

The object derived and set out above is further achieved according to a second aspect of teaching of the present invention in a furniture component
having a plate-like material which has at least one narrow face and an upper side and a lower side, and
having at least one edge profile,
   in that the edge profile is produced by a method as described above.

According to an embodiment of the furniture component according to the invention, there is provision for the upper side and/or the lower side of the plate-like material to be provided with a coating which has a decoration and in particular a three-dimensional structure which is preferably at least substantially congruent with the decoration of the coating of the plate-like material. The furniture component may therefore also have on the main sides (upper side and/or lower side) a structure with a synchronous decoration, for example, a wood decoration with corresponding wood structure.

According to another embodiment of the furniture component according to the invention, there is provision for the decoration of the coating of the plate-like material to correspond to the decoration of the edge profile and/or the structure of the coating of the plate-like material to correspond to the structure of the edge profile. Preferably, therefore, the structure is identical in the region of the upper-side or lower-side surface and the narrow face. This is preferably also the case for the decoration. In the case of a wood decoration, the coating of the upper side or lower side and the edge profile can thereby imitate the surface of longitudinally cut timber visually and haptically.

According to an alternative embodiment of the furniture component according to the invention, there is provision for the decoration of the coating of the plate-like material to be different from the decoration of the edge profile and/or the structure of the coating of the plate-like material to be different from the structure of the edge profile. In the case of a wood decoration, the edge profile which differs from the coating of the main face(s) in terms of decoration and structure can thereby imitate the visual appearance and haptics of the surface of timber cut in the cross-grain direction.

There may in particular be provision for the decoration and structure of the coating of the plate-like material to represent the decoration and structure of longitudinally cut timber and the decoration and structure of the edge profile to represent the decoration and structure of timber cut in the cross-grain direction.

In order to obtain a particularly realistic impression, there may further be provision for an edge profile which is produced in the manner described to be applied to two narrow sides which meet each other in a corner of the plate-like material, wherein both edge profiles have a structure which has a synchronous decoration and which is identical at least in a portion which abuts the respective end of the edge profile or completely, wherein an offset in the direction which extends perpendicularly to the plane in which the upper and lower edges of the narrow face extends, between the structure which has a synchronous decoration at the end of one edge profile and the structure which has a synchronous decoration at the end of the other edge profile is at a maximum 0.5 mm, preferably at a maximum 0.35 mm, particularly preferably at a maximum 0.2 mm. This particularly applies to all the corners of a plate-like material, in which two edge profiles meet each other with a structure which has a synchronous decoration. In this context, the term “corner” is intended to refer to the edge in which the two narrow faces meet each other and which extends from the upper side to the lower side of the plate-like material.

There are now a large number of possible ways of configuring and developing the method according to the invention and the furniture component according to the invention. In this regard, reference may be made, on the one hand, to the claims which follow claims 1 and 19 and, on the other hand, to the description of embodiments in connection with the drawings. In the drawings:

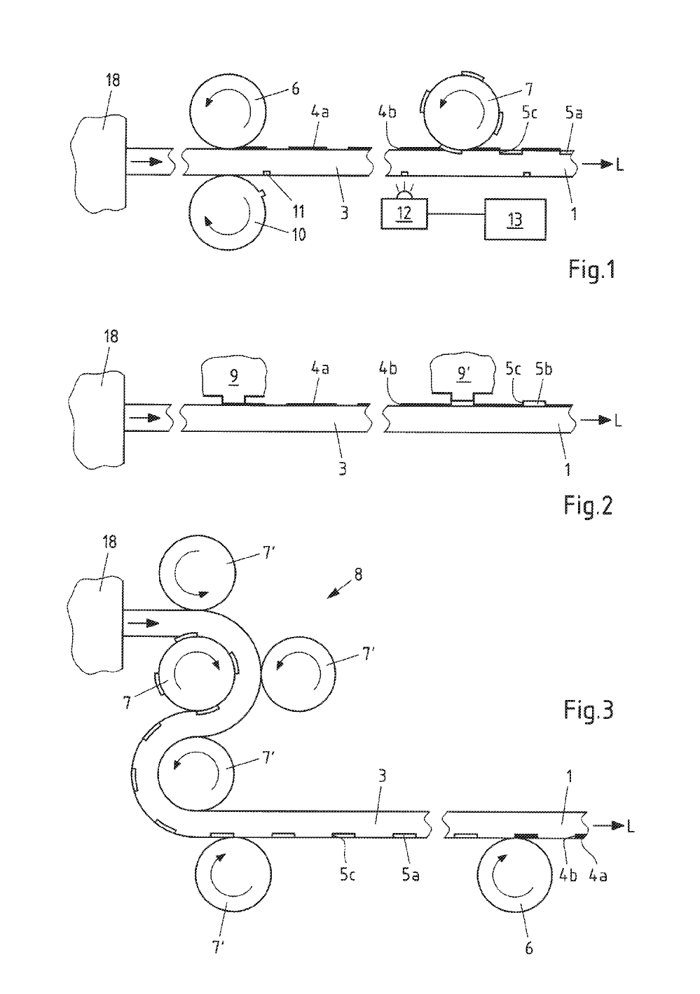

FIG. 1 is a schematic illustration of the production of an edge profile according to a first embodiment of the method according to the invention,

FIG. 2 is a schematic illustration of the production of an edge profile according to a second embodiment of the method according to the invention,

FIG. 3 is a schematic illustration of the production of an edge profile according to a third embodiment of the method according to the invention,

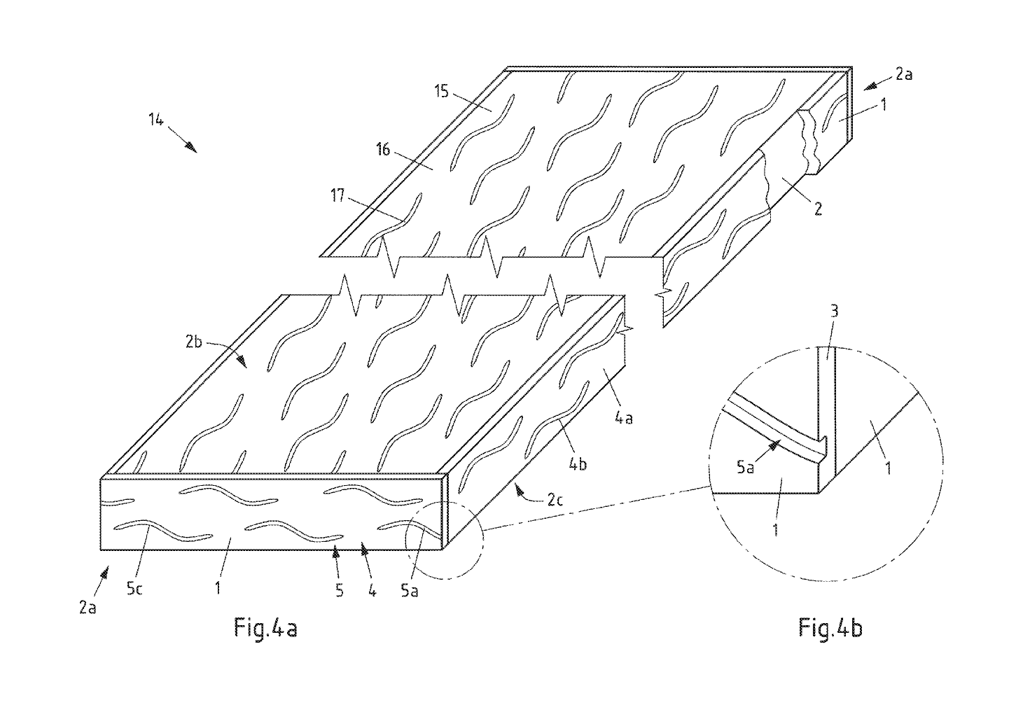

FIGS. 4a and b are schematic illustrations of a first embodiment of a furniture component according to the invention, and

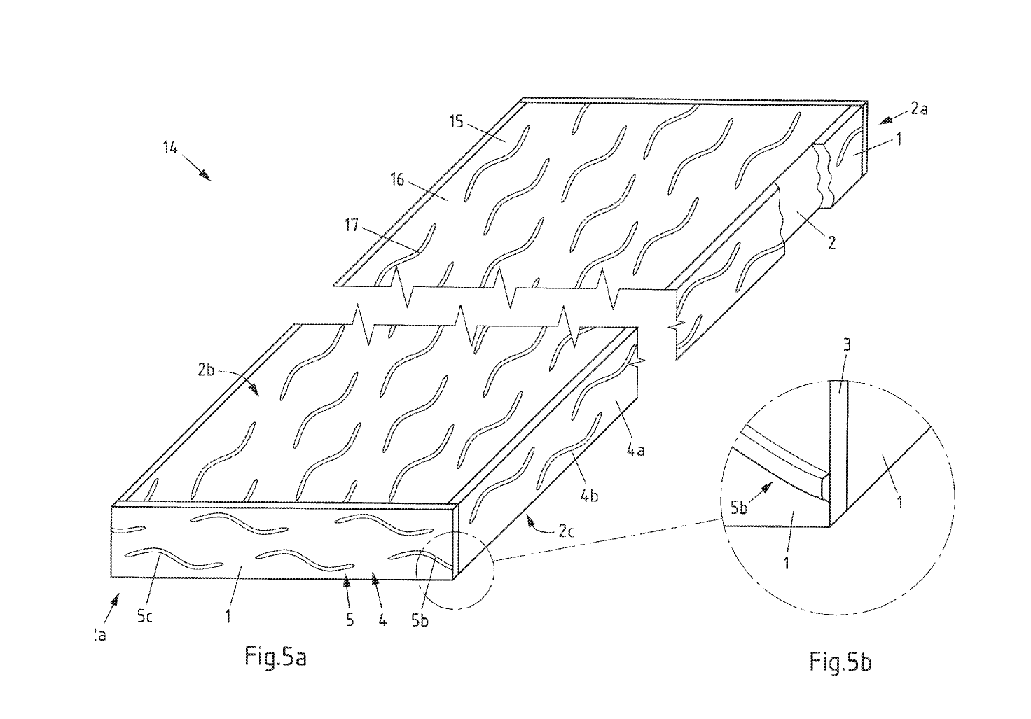

FIGS. 5a and b are schematic illustrations of a second embodiment of a furniture component according to the invention.

FIG. 1 illustrates by way of example the production of an edge profile 1 for installation to a narrow face 2a of a plate-like material 2. FIGS. 2 and 3 show additional variants of the method. FIGS. 4a) and b) show a furniture component 14 comprising a plate-like material 2 which has a corresponding edge profile 1. FIGS. 5a) and b) show an alternative embodiment of a furniture component 14 with an edge profile 1.

The following common basic principle forms the basis of the different variants of the method illustrated in FIGS. 1 to 3 for producing an edge profile 1.

Thus, in the method according to the invention initially an edge strip 3 which extends in a longitudinal direction L is provided or produced in the form of a continuous strip. The production can be carried out, for example, by extrusion of a thermoplastic plastics material or compression of a layer structure comprising papers which are impregnated with a thermosetting plastics material (resin).

The edge strip 3 is provided during or after the production thereof with both a decoration 4 and a three-dimensional structure 5. In this case, the decoration 4 is produced by a partial dye application so that regions which are provided with dye 4a adjoin regions which are not printed or which are differently printed. The regions provided with dye 4a each form a decoration element 4b.

The structure 5 can be produced either by providing recesses 5a or projections 5b on the edge strip 3, wherein the recesses 5a or projections 5b are delimited by at least one edge 5c. Recesses 5a can be produced, for example, by embossing and projections 5b by material application, for example, lacquer application.

Whether the edge strip 3 is first provided with the decoration 4 and subsequently with the three-dimensional structure 5 or first with the three-dimensional structure 5 and subsequently with the decoration 4 is of secondary importance for the fundamental principle of the present invention. The sequence can vary here in accordance with the specific case and desired result.

As explained below with reference to the embodiments in FIGS. 1 to 3, it is significant in the method according to the invention that the decoration 4 and the structure 5 are arranged in such a manner that the structure 5 is at least substantially congruent with the decoration 4. Therefore, according to the invention a so-called structure 5 having a synchronous decoration is produced. The term “substantially” is intended to be understood to mean that, although ideally a portion of the structure 5, in particular the said recess 5a or the said projection 5b, extends congruently with the decoration element 4b of the decoration 4, wherein tolerance-related, slight displacements or a slight offset in the longitudinal direction L or transversely thereto cannot be excluded. A possible offset can be prevented, however, by a control device 13 which is described in detail below.

As already indicated, the edge strip 3 can in principle comprise a one-layered or multi-layered layer structure comprising papers which are impregnated with a thermosetting resin. In this case, the decoration 4 can also, at least partially, be applied to one of the layers of the layer structure, for example, to a paper which is impregnated with resin or not yet impregnated with resin, wherein subsequently the edge strip 3 is then produced from the layer structure, for example, by the compression mentioned.

However, the method is explained by way of example below with reference to FIGS. 1 to 3 for an edge profile 1, in which the edge strip 3 comprises a thermoplastic plastics material.

FIGS. 1 and 2 schematically illustrate an extruder 18 for a single-strand extrusion which produces an edge strip 3. However, FIG. 3 illustrates an extruder 18′ of a calender 8.

FIG. 1 schematically illustrates a method, in which the extruded edge strip 3 is provided in a first step with a decoration 4 and subsequently in a subsequent step with a structure 5. To this end, the extruded edge strip 3 is guided in a longitudinal direction L initially past an impression cylinder 6 and subsequently past an embossing roller 7. Dye 4a is partially applied repeatedly at the front side to the edge strip 3 with the impression cylinder 6 by means of an intaglio printing method. The regions which are provided with dye 4a form with the remaining surface of a decoration 4.

The downstream embossing roller 7 subsequently embosses in the case of FIG. 1 recesses 5a between the regions which are provided with dye 4a. The recesses 5a together form a structure 5. In this case, the respective recess 5a extends congruently with the respective decoration element 4b which is formed by the region which is provided with dye 4a. In this manner, a structure 5 which has a synchronous decoration is provided.

FIG. 2 schematically shows a method in which the extruded edge strip 3 is also initially provided with a decoration 4 and subsequently with a structure 5. Here, however, the dye 4a of the decoration 4 is applied by a printing head 9, for example, an ink jet printing head 9, by means of a digital printing method.

The three-dimensional structure 5 is also produced by means of a printing head 9′ using a digital printing method by the printing head 9′ applying plastics material, for example, coloured or colourless and/or matt or brilliant lacquer, between the regions which are provided with dye 4a. The material which is applied by the printing head 9′ has in this case a higher layer thickness than the dye 4a previously applied by the printing head 9 so that projections 5b which form the structure 5 are produced here.

For a particularly good result, there may also be provision for the structure 5, in particular the structure 5 which is produced by digital printing, to be detected by an optical detection device (not illustrated), for example, a camera, and for the decoration printing to be adapted to the detected position of the structure 5 in relation to the longitudinal direction L. The transposed case is also conceivable in which first the decoration 4 and then the structure 5 is provided on the edge strip 3, wherein the decoration 4 is detected by an optical detection device (not illustrated), for example, a camera, and the embossing of the structure 5 to be adapted to the detected position of the decoration 4 in relation to the longitudinal direction L.

In the method in FIG. 3, the extruded edge strip 3 is guided along between a plurality of calender rollers 7 or 7′ after being discharged from the extruder 18′ and is formed. One of the calender rollers 7 or 7′ is in this embodiment an embossing roller 7 which embosses a structure 5 into the edge strip 3 similarly to the case in FIG. 1.

In order to optimise the embossing result, various additional measures are conceivable. Thus, the calender roller 7 which embosses the structure 5 is in this case a portion of the first roller pair 7/7′, with which the extruded edge strip 3 first comes into contact after being discharged from the extruder 18′, whereby the edge strip is still relatively soft. The calender roller 7 is further arranged relative to the extruder 18′ in particular and/or the extruded edge strip 3 is in particular guided from the extruder 18′ so that the extruded edge strip 3 extends around the embossing calender roller 7 by at least 90°, preferably by at least 135°, particularly preferably by at least 180°, and thus is in contact with the structuring roller 7 for a particularly long time.

An impression cylinder 6 similar to the one illustrated in FIG. 1 which also applies dye 4a to the edge strip 3 with the intaglio printing method is connected downstream of the calender 8. In this case, however, the dye 4a is introduced into the recesses 5a of the structure 5 produced previously by the embossing roller 7. No dye or another dye which was then applied separately (not illustrated) is located outside the recesses 5a.

So that the recesses 5a or projections 5b which form the structure 5 extend synchronously (congruently) according to the invention with the respective decoration elements 4b, that is to say, with the regions of the decoration 4 provided with dye 4a, various measures are conceivable.

On the one hand, there may be provision for the circumference of the respective impression cylinder 6 and the circumference of the respective embossing roller 7 to be selected in such a manner that, when the edge strip 3 comes into contact with the respective impression cylinder 6 and the respective embossing roller 7, the decoration 4 and the structure 5 are brought into an overlapping state with each other (at least substantially). In this case, the degree of overlap between the decoration 4 and structure 5 does not change. Here, this is firstly achieved in that the circumference of the respective embossing roller 7 corresponds to the circumference of the respective impression cylinder 6 so that the impression cylinder 6 and embossing roller 7 run at the same rotation speed or rolling speed.

On the other hand, as shown in FIG. 1, there may be provided a separate marking device 10 which automatically provides on the edge strip 3 at regular intervals over the length L of the edge strip 3 markings 11 which can be used for control purposes. In FIG. 1, the markings 11 are embossed. However, it is also conceivable to print markings 11. Such markings can also be provided in the embodiments in FIGS. 2 and 3.

The markings 11 are provided in FIG. 1 by way of example on the rear side, that is to say, the side facing away from the decoration 4 and structure 5, of the edge strip 3. In principle, however, the markings 11 could also be provided at a different location, for example, at the edge of the edge strip 3 and/or at the upper side and/or inside the decoration 4 and/or inside the structure 5.

The respective marking 11 is detected in FIG. 1 by way of example by a scanning device 12, in this case an optical sensor 12, and used by a control device 13 for controlling the advance speed of the edge strip 3 and/or the rotation speed of the embossing roller 7. In the event that the impression cylinder 6 is connected downstream of the embossing roller 7, as illustrated in FIG. 3 by way of example, the respective marking 11 is preferably used to control the rotation speed of the impression cylinder 6.

The control device 13 compares the established position of the respective marking 11, for example, with the established angular position of the impression cylinder 6 or the embossing roller 7 relative to the edge strip surface and carries out an adjustment of the rotation speed of the impression cylinder 6 or embossing roller 7 on the basis of the comparison result if an offset between the decoration 4 and structure 5 exceeds a specific desired value.

As set out, alternatively or additionally the advance speed of the edge strip 3 can also be varied as a result of the comparison result if a desired value is exceeded for the offset, for example, by changing the extrusion speed and/or by changing the transport speed of the transport device or individual portions of the transport device (not illustrated), on which the extruded edge strip 3 is transported in the longitudinal direction L. The control device 13 can also carry out, in the manner described, an extension or compression of portions of the edge strip 3 in a longitudinal direction L in order thereby to prevent any offset between the decoration 4 and structure 5.

FIGS. 4a and b illustrate by way of example a furniture component 14 which is formed by a plate-like material 2 which is coated on the narrow faces 2a and on the upper side 2b and the lower side 2c thereof.

In this case, the upper side 2b and the lower side 2c of the plate-like material 2 are provided with a coating 15 here, for example, a paper-based, compressed laminate, wherein the coating 15 has, on the one hand, a decoration 16 and, on the other hand, a three-dimensional structure 17, which is a structure 17 having a synchronous decoration.

The narrow faces 2a are provided with an edge profile 1 which has been produced according to the above-described method according to the invention. The edge profile 1 also has a decoration 4 and a three-dimensional structure 5, wherein the structure 5 is a structure 5 having a synchronous decoration.

In this case, the decoration 4 and structure 5 of the edge profile 1 are identical to the decoration 16 and structure 17 of the upper-side and lower-side coating 15 of the plate-like material 2.

In the embodiment of a furniture component 14 in FIGS. 4a) and 4b), the three-dimensional structure 5 comprises a large number of recesses 5a which are embossed in the edge profile 1. The structure 17 is formed accordingly.

The additional embodiment of a furniture component 14 which is illustrated in FIGS. 5a) and b) is substantially comparable with the embodiment in FIGS. 4a) and b), with the difference that the three-dimensional structure 5 of the edge profile 1 is formed here by a large number of projections 5b. This also applies to the structure 17 of the coating 15.

1. A method for producing an edge profile for a furniture component, the method comprising:
providing an edge strip, which extends in a longitudinal direction, with a decoration; and
wherein the edge strip is provided with a three-dimensional structure,
wherein the decoration and the structure are configured so that the structure is at least substantially congruent with the decoration and the edge strip is produced by extruding a thermoplastic plastics material.

2. (canceled)

3. The method according to claim 1, further comprising providing the edge strip with the structure within a time period after the production of the edge strip, in particular extrusion, wherein the plastics material of the edge strip does not yet have the definitive form stability.

4. The method according to claim 1, further comprising providing the edge strip with the structure within a time period after the production of the edge strip, in particular extrusion, in which the plastics material of the edge strip already has the definitive form stability.

5. The method according to claim 1, further comprising providing the edge strip first with the decoration and subsequently with the structure.

6. The method according to claim 1, wherein the edge strip is provided first with the structure and subsequently with the decoration.

7. The method according to claim 1, further comprising applying the decoration to the edge strip by means of intaglio printing, in particular indirect intaglio printing, using one or more impression cylinder.

8. The method according to claim 1, further comprising impressing the structure into the edge strip by means of one or more embossing roller(s).

9. The method according to claim 8, wherein the at least one embossing roller is a calender roller of a calender.

10. The method according to claim 8, further comprising selecting the circumference of the impression cylinder(s) and the embossing roller(s) in such a manner that, if the edge strip comes into contact with impression cylinder(s) and embossing roller(s), the decoration and structure are moved so as to at least substantially overlap with each other.

11. The method according to claim 8, wherein the circumference of the embossing roller(s) corresponds to the circumference of the impression cylinder(s) or an integral multiple of the circumference of the impression cylinder(s).

12. The method according to claim 8, wherein the circumference of the impression cylinder(s) corresponds to an integral multiple of the circumference of the embossing roller(s).

13. The method according to claim 1, further comprising applying the decoration to the edge strip by means of digital printing.

14. The method according to claim 9, further comprising providing
a printing device for digital printing, or
the impression cylinder, one of the impression cylinders,
the embossing roller, one of the embossing rollers, or
a separate marking device
for a marking on the edge strip several times, in particular at regular intervals.

15. The method according to claim 14, further comprising providing the respective marking as a separate marking on the edge of the edge strip, on the rear side of the edge strip, or is integrated in the decoration and/or the structure.

16. The method according to claim 14, further comprising detecting the respective marking, in particular with a scanning device, and is used by a control device to control the advance speed of the edge strip, the printing speed of a device for digital printing, the rotation speed of the impression cylinder(s), the embossing roller(s), and/or to adapt the digital decoration intended to be printed.

17. The method according to claim 16, further comprising comparing the position of the respective marking with the angular position of the impression cylinder(s) and/or the embossing roller(s) and carrying out a control operation on the basis of the comparison result.

18. The method according to claim 16, further comprising comparing the position of the respective marking with the position of the device for digital printing, in particular the printing head, and carrying out a control operation on the basis of the comparison result.

19. A furniture component comprising:
a plate-like material having at least one narrow face, an upper side, and a lower side; and
at least one edge profile, in particular produced by the method according to claim 1,
wherein the edge profile is an extruded edge strip which extends in a longitudinal direction and which has a decoration and a three-dimensional structure, wherein the decoration and the structure are configured so that the structure is at least substantially congruent with the decoration.

20. The furniture component according to claim 19, wherein the upper side and/or the lower side of the plate-like material is provided with a coating having a decoration and in particular a three-dimensional structure which is at least substantially congruent with the decoration of the coating of the plate-like material.

21. The furniture component according to claim 20, wherein the decoration of the coating of the plate-like material corresponds to the decoration of the edge profile and/or the structure of the coating of the plate-like material corresponds to the structure of the edge profile.

22. The furniture component according to claim 20, wherein the decoration of the coating of the plate-like material is different from the decoration of the edge profile and/or the structure of the coating of the plate-like material is different from the structure of the edge profile.

23. The furniture component according to claim 20, wherein the decoration and structure of the coating of the plate-like material represent the decoration and structure of timber cut longitudinally and the decoration and structure of the edge profile represent the decoration and structure of timber cut in the cross-grain direction.
